(19) United States
(12) Patent Application Publication
(10) Pub. No.: US 2016/0286479 A1
(43) Pub. Date: Sep. 29, 2016

(54) REDUCING ENERGY CONSUMPTION OF SMALL CELL DEVICES

(71) Applicant: ALCATEL LUCENT, Boulogne-Billancourt (FR)

(72) Inventors: Kiran KARKERA, Bangalore (IN); Rakesh CHELLA, Bangalore (IN)

(21) Appl. No.: 15/036,922

(22) PCT Filed: Nov. 17, 2014
(86) PCT No.: PCT/EP2014/074791

§ 371 Date: May 16, 2016

(30) Foreign Application Priority Data
Dec. 5, 2013 (IN) 3532/DEL/2013

(51) Int. Cl. H04W 52/02; H04W 76/04

(52) U.S. Cl. CPC H04W 52/0206; H04W 76/048; H04W 76/046

(57) ABSTRACT

Method(s) and system(s) for reducing energy consumption of small cell devices (110) are disclosed. The method may include receiving a predicted usage state of a cluster comprising at least one small cell device (110). The cluster is formed based on a pattern of usage and the predicted usage state is indicative of information relating to operation of the at least one small cell device (110). The method may further include determining an action to be taken for the cluster based on the predicted usage state. The action relates to one of maintaining and changing an operational state of the at least one small cell device (110).

### FIELD OF INVENTION

The present subject matter relates to small cell devices and, more particularly but not exclusively, to reducing energy consumption of small cell devices.

### BACKGROUND

In recent times there has been a rapid increase in use of cellular devices and cellular services, resulting in tremendous growth of cellular data traffic. To handle the cellular data traffic, and communication between the cellular devices and networks, communications service providers use macrocells. A macrocell may be understood as a high power cellular base station which provides coverage in a network. Typically, macrocells are deployed in densely populated areas, such as large offices, malls, and railway stations. Since the cellular data traffic is increasing globally at a rapid rate, the communications service providers are using small cell devices, in addition to the macrocells, to increase network capacity. A small cell device is a low power cellular base station which provides a low power signal much closer to cellular users on their cellular devices in comparison to the macrocells. The small cell devices encompass microcell devices, metrocell devices, picocell devices and femtocell devices, and are typically deployed in varied environments, such as homes, small offices, stadiums, and airports.

### SUMMARY

This summary is provided to introduce concepts related to systems and methods for reducing energy consumption of small cell devices. This summary is neither intended to identify features of the claimed subject matter nor is it intended for use in determining or limiting the scope of the claimed subject matter.

In one aspect, the present subject matter discloses a device management system for reducing energy consumption of small cell devices. The device management system may include a processor and a signaling module coupled to the processor. The signaling module may receive a predicted usage state of a cluster comprising at least one small cell device. The cluster is formed based on a pattern of usage and the predicted usage state is indicative of information relating to operation of the at least one small cell device. The signaling module may further determine an action to be taken for the cluster based on the predicted usage state. The action relates to one of maintaining and changing an operational state of the at least one small cell device,

In another aspect, the present subject matter discloses a method for reducing energy consumption of small cell devices. The method may include receiving a predicted usage state of a cluster comprising at least one small cell device. The cluster is formed based on a pattern of usage and the predicted usage state is indicative of information relating to operation of the at least one small cell device. The method may further include determining an action to be taken for the cluster based on the predicted usage state. The action relates to one of maintaining and changing an operational state of the at least one small cell device.

In yet another aspect, the present subject matter discloses a computer readable medium having embodied thereon a computer program for executing a method for reducing energy consumption of small cell devices. The method may include receiving a predicted usage state of a cluster comprising at least one small cell device. The cluster is formed based on a pattern of usage and the predicted usage state is indicative of information relating to operation of the at least one small cell device. The method may further include determining an action to be taken for the cluster based on the predicted usage state. The action relates to one of maintaining and changing an operational state of the at least one small cell device.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system or methods in accordance with embodiments of the present subject matter are now described, by way of example, and with reference to the accompanying figures, in which:

FIG. 1 illustrates a network environment implementing an energy consumption management (ECM) system, in accordance with an embodiment of the present subject matter; and

FIG. 2 illustrates a method for reducing energy consumption of small cell devices, in accordance with an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like, represent various processes which may be substantially represented in computer readable medium and so executed by a computer or processor, whether or not such computer or processor is explicitly shown.

### DESCRIPTION OF EMBODIMENTS

Since cellular data traffic is growing exponentially at a rapid rate, communications service providers are using small cell devices, in addition to macrocells, to increase network capacity. As may be known, small cell devices are low power cellular base stations. Examples of small cell devices include microcell devices, picocell devices, metrocell devices, and femtocell devices. The small cell devices are deployed in heavy traffic areas, such as indoor commercial spaces, homes, and sports arenas to augment the network capacity. To provide cellular services, the small cell devices are generally kept ON at all times. However, there may be scenarios where the small cell devices may not be serving cellular devices at all times. For example, small cell devices deployed in a residence may be idle when no one is at home. In another example, the small cell devices deployed in an enterprise may be idle in non-business hours and on holidays. Therefore, in such scenarios where the small cell devices are unnecessarily active, there is wastage of energy by the small cell devices.

Conventionally, to reduce unnecessary consumption of energy of the small cell devices, a pre-defined time schedule based policy is implemented. Based on the policy, at pre-defined scheduled times, transmit power of the small cell devices is reduced, or cellular service is disabled, or the small cell devices are kept in a dormant state. However, implementation of this policy to reduce unnecessary consumption of energy of the small cell devices may pose certain challenges. For example, in case number of deployed small cell devices is huge and the deployments are diverse, formulation of an efficient time schedule based policy may be cumbersome, time consuming and prone to errors. Further, the small cell devices may have varied usage patterns with respect to time. For example, if some of the small cell devices are deployed in a small office, then those small cell devices may be used from 9 AM to 9 PM, every day, and if remaining small cell devices are deployed in a stadium, then those small cell devices may be used from 6 AM to 9 AM and from 5 PM to 8 PM, every day. As a result, application of a common time schedule based policy to the small cell devices having such varied usage patterns to reduce energy consumption of the small cell devices may be difficult. Therefore, the conventional method or policy for reducing unnecessary consumption of energy of the small cell devices may be inefficient in terms of performance.

According to an implementation of the present subject matter, systems and methods for reducing energy consumption of small cell devices are described herein. The system described herein is an energy consumption management (ECM) system. The ECM system clusters the small cell devices into one or more clusters based on their usage patterns.

For each cluster, the ECM system predicts a usage state based on prediction parameters. The prediction parameters may be indicative of information relating to the small cell devices. Based on the predicted usage states and a pre-defined schedule policy of the small cell devices, the ECM system determines an action to be taken on each cluster of the small cell devices to reduce the energy consumption of the small cell devices.

Since usage pattern of each small cell device is taken into consideration to cluster the small cell devices into one or more clusters, and usage state for each cluster is predicted, it becomes easy to target each cluster as a whole and separate policies need not be defined for the numerous individual small cells. Also, there is no need to determine an action for each and every small cell device. An action is determined for each cluster of the small cell devices. As a result, less time is consumed and it becomes easy to control or manage the small cell devices. Thus the small cell devices are not unnecessarily ON to avoid wastage of power and at the same time are not OFF when they may be required to provide cellular services. Thus, the ECM system reduces energy consumption of the small cell devices in a time efficient and error free manner.

In one embodiment, the ECM system for reducing energy consumption of the small cell devices comprises a device management system and a prediction system. The device management system and the prediction system are communicatively coupled to each other. The small cell devices are also communicatively coupled to the ECM system. A communications service provider may control the small cell devices through the ECM system or based on inputs provided by the ECM system. Although it has been described that the prediction system is external to the device management system, it will be appreciated that the prediction system can be integrated within the device management system.

In one implementation of the present subject matter, the device management system may enable performance management (PM) counters on each small cell device. The PM counters may be understood as measurements of various parameters of the small cell devices. The PM counters gather information relating to the small cell devices. The PM counters may gather data related to a number of active calls of the cellular devices, a number of hand-ins from neighbour small cell devices, and a number of connected cellular devices. In one example, to enable the PM counters, the device management system may invoke technical report 069 (TR-069) remote procedure calls (RPC) “SetParameterValues”, on parameters related to the PM counters.

Once the PM counters are enabled on the small cell devices, the prediction system may receive performance management (PM) data from the small cell devices, for example, via a network. The small cell devices may generate the PM data for the PM counters which were enabled by the device management system. The PM data may be indicative of information relating to usage patterns of the small cell devices with respect to time, performance of the small cell devices, and traffic load in the small cell devices. The prediction system may store the PM data, received from the small cell devices, in a database. The database can be an external repository associated with the prediction system, or an internal repository within the prediction system. The PM data stored in the database may be retrieved whenever the process of reducing the energy consumption of the small cell devices has to be initiated. Further, the PM data contained within the database may be periodically updated, whenever required.

Upon receiving the PM data, the prediction system may cluster the small cell devices based on the PM data. For example, the prediction system may cluster the small cell devices into one or more clusters based on the usage patterns of the small cell devices. Referring to the example, the prediction system may group the small cell devices having similar usage pattern into one cluster. In one implementation, the prediction system may use a clustering algorithm, such as an independent component analysis (ICA) clustering algorithm, k nearest neighbours or k-means clustering algorithm to cluster the small cell devices.

For example, small cell devices deployed in a residence, where the residents may be at work during working hours, may be serving one or more cellular devices when at least one resident is at home and may be idle during other hours when no one is at home. Similarly, small cell devices deployed in an office may be serving cellular devices throughout working hours and may be idle during non-working hours. Therefore, the prediction system may cluster the small cell devices into two clusters, one cluster having small cell devices deployed in the residence and other cluster having small cell devices deployed in the office.

The prediction system may then provide the clusters of the small cell devices to the device management system. The device management system may associate a label with each cluster of the small cell devices. The label may be a distinctly identifiable name. For example, the device management system may associate a label “residence device” with the cluster having the small cell devices deployed in the residence and may associate a label “office devices” with the cluster having small cell devices deployed in the office. By associating labels with the small cell devices, it may become easy for the device management system to target small cell devices contained in each cluster as a whole. Further, information of the small cell devices, such as labels associated with each cluster of small cell devices may be provided to the prediction system by the device management system.

The prediction system may predict a usage state for each cluster of the small cell devices for a given time interval. The predicted usage state may be indicative of information relating to operation of the small cell devices in the cluster. The predicted usage states may include dual states and multiple states. In one example, the predicted usage state may be one of HIGH and LOW. In another example, the predicted usage state may be one of LOW, MEDIUM, and HIGH. The prediction system may predict the usage state for a cluster based on a pattern of usage of the small cell devices in the cluster. In one implementation, prediction of the usage states of the clusters may also be based on a plurality of prediction parameters data. The prediction parameters may be indicative of information relating to the small cell devices. For example, the prediction parameters may include device parameters, performance data of the small cell devices, and environmental data. The device parameters may be related to radio resource control (RRC) of the small cell devices, radio link control (RLC) of the small cell devices, Handovers to and from the small cell devices, etc. The environmental data may be, for example, day of a week, time of the day, etc. The performance data may include usage of the small cell devices in past pre-determined minutes, usage of the small cell devices at the pre-determined time for past pre-specified days, and average load on nearby macrocells in the past pre-determined minutes. The pre-specified days may be any number of days. In one example, the quantum of the preceding time (number of minutes or days) may be determined based on the required prediction performance of the prediction system.

Upon predicting the usage states for the clusters for the given time intervals, the prediction system may transmit the predicted usage states to the device management system through the network.

Although the foregoing description has been described with reference to prediction of one usage state for a cluster for a given time interval, it is well appreciated that predictions may be made for any given cluster periodically for any specified time instance or time interval. Further, duration of the time intervals for each usage state may vary. In one implementation, the communications service provider who may be controlling the small cell devices, may provide the time intervals for which usage states of each cluster has to be determined.

The device management system may determine an action to be taken for each cluster. The action may be understood as one of maintaining and changing an operational state of the small cell devices. In one implementation, the action may be determined based on the predicted usage state and a pre-defined schedule policy to reduce energy consumption of the small cell devices. The operational state may be either an active mode or an inactive mode. Further, the pre-defined schedule policy may be indicative of a time schedule comprising one or more time intervals during which the small cell devices have to be kept on an active mode or on an inactive mode. In one implementation, the schedule policy may be made available to the device management system by a communications service provider who is controlling the small cell devices. In said implementation, the communications service provider may formulate the schedule policy based on user's choice. The user may be understood as a person who has deployed the small cell devices in a deployment area. For example, the user may be an owner of a house, a public entity managing a public deployment, etc.

Further, the action to be taken on the small cell devices may include one of reducing radio frequency (RF) power of the small cell devices, enabling standby mode of the small cell devices, switching OFF the small cell devices, and continuing a present mode of the small cell devices, the present mode being one of an active mode and an inactive mode. The present mode of the small cell devices is interchangeably referred to as the operational state of the small cell devices. In one implementation, the action on the small cell devices may be taken the communications service provider. In another implementation, the action on the small cell devices may be pre-selected by the communications service provider. The communications service provider may select an action from the above listed action for each cluster of small cell devices to reduce energy consumption of the small cell devices.

Referring to the previous example, a predicted usage state of the “office devices” cluster may be LOW for a time interval between 9 PM to 9 AM on working days, and for the time interval between 9 AM to 9 PM on the working days, a predicted usage state may be HIGH. Further, according to the pre-defined schedule policy, the small cell devices in the “office devices” may be kept on an inactive mode for time interval between 9 AM to 10 AM, for example, if most of the employees reach office by 10 AM. In such a case, the network may select an action “enable standby mode” for the small cell devices contained in the “office devices” cluster, thereby reducing energy consumption of the small cell devices in the “office devices” cluster from 9 AM to 10 AM. The pre-defined schedule policy may also define that the small cell devices contained in the “office devices” may be kept on an active mode for time interval between 9 PM to 10 PM, if the usage pattern indicated that most of the employees may work till late. In such a case, the network may select an action “continue a present mode” for the small cell devices contained in the “office devices” cluster.

Since usage pattern of each small cell device is taken into consideration to cluster the small cell devices into one or more clusters, and usage state for each cluster is predicted, it becomes easy to target each cluster as a whole and separate policies need not be defined for the numerous individual small cell devices. Also, there is no need to determine an action to be taken for each and every small cell device. An action is generated for each cluster of small cell devices. As a result, less time is consumed and it becomes easy to manage the small cell devices. Thus, according to the present subject matter, energy consumption of small cell devices is efficiently reduced, without any errors.

It should be noted that the description and figures merely illustrate the principles of the present subject matter. It will thus be appreciated that those skilled in the an will be able to devise various arrangements that, although not explicitly described or shown herein, embody the principles of the present subject matter and are included within its spirit and scope. Furthermore, all examples recited herein are principally intended expressly to be for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the words “connected” and “coupled” are used throughout for clarity of the description and can include either a direct connection or an indirect connection.

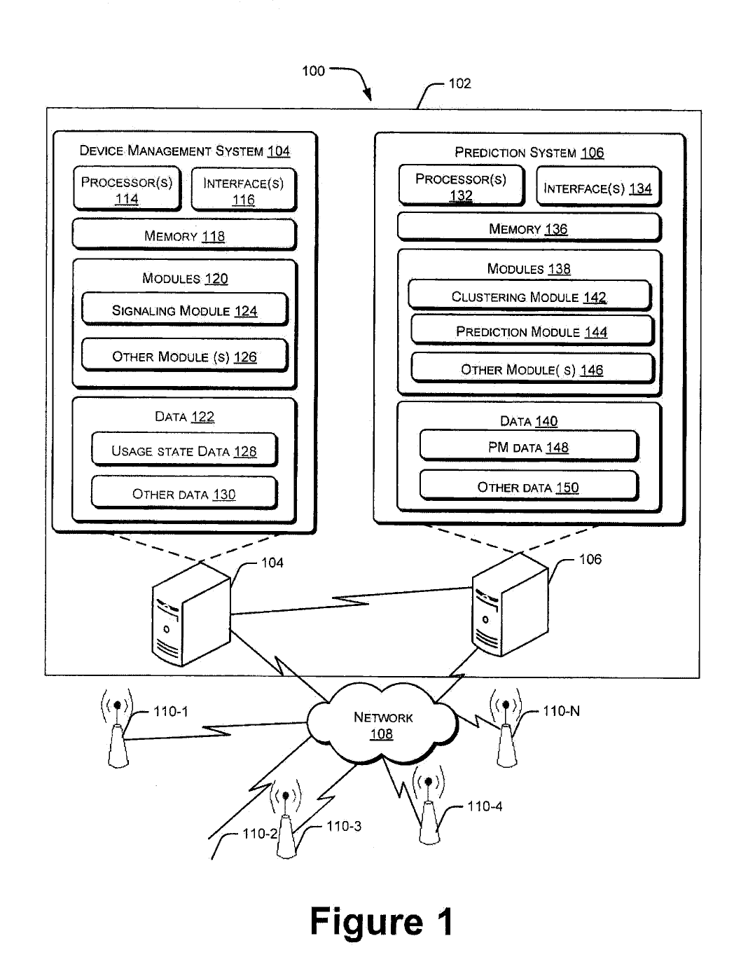

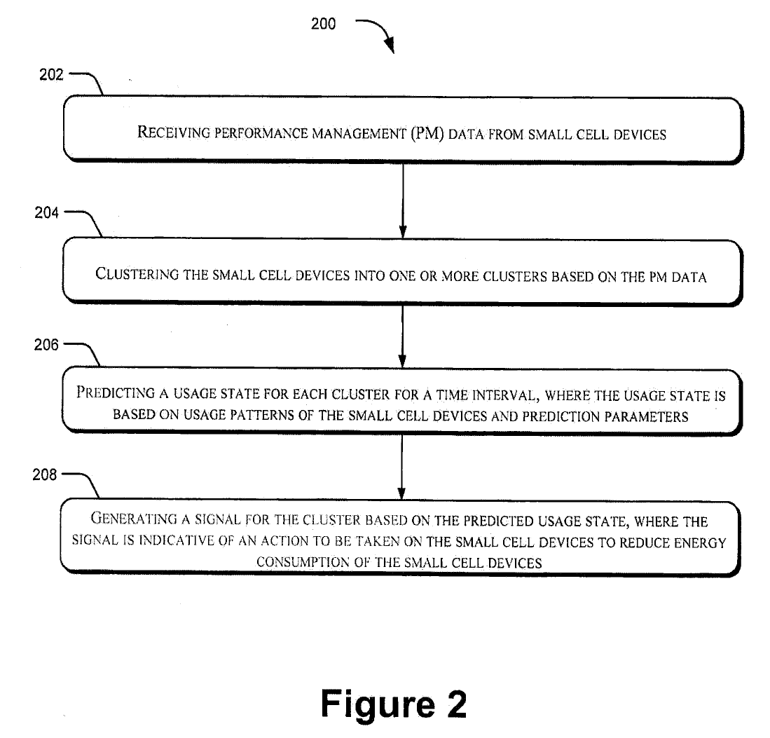

The manner in which the systems and the methods of reducing energy consumption of small cell devices may be implemented has been explained in details with respect to the FIGS. 1 and 2. While aspects of described systems and methods for reducing energy consumption of small cell devices can be implemented in any number of different computing systems and transmission environments, the embodiments are described in the context of the following system(s).

FIG. 1 illustrates a network environment 100 implementing an energy consumption management (ECM) system 102, in accordance with an embodiment of the present subject matter.

In one embodiment, the ECM system 102 comprises of a device management system 104 and a prediction system 106. The device management system 104 and the prediction system 106 described herein, can be implemented in any network environment comprising a variety of network devices, including routers, bridges, servers, computing devices, storage devices, etc.

The prediction system 106 and the device management system 104 can be implemented as a variety of servers and communication devices. The communication devices that can implement the described method(s) include, but are not limited to, central directory servers, database server, web server, application server, and the like. The prediction system 106 and the device management system 104 may also be implemented as a computing device, such as a laptop computer, a desktop computer, a notebook, a workstation, a mainframe computer, a server, and the like.

Although it has been shown in FIG. 1 that the prediction system 106 is external to the device management system 104, it will be appreciated that prediction system 106 can be integrated within the device management system 104. In other words, in one implementation, a computing system may implement the functionalities of the prediction system 106 as well as the device management system 104.

In one implementation, the device management system 104 may be communicatively coupled to the prediction system 106 through a network 108. The network 108 may be a wireless or a wired network, or a combination thereof. The network 108 can be a collection of individual networks, interconnected with each other and functioning as a single large network (e.g., the internet or an intranet). Examples of such individual networks include, but are not limited to, Internet Protocol (IP) network, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the network 108 includes various network entities, such as gateways, routers; however, such details have been omitted for ease of understanding.

In one implementation, the ECM system 102 may be deployed at a communications service provider's premise. Further, the ECM system 102 is coupled to one or more small cell devices 110-1, 110-2, 110-3, 110-4, . . . , 110-N, individually and commonly referred to as small cell device(s) 110 hereinafter, through the network 108. The small cell devices 110 are low power cellular base stations. Examples of the small cell devices 110 include microcell devices, metrocell devices, picocell devices and femtocell devices. The small cell devices 110 are deployed in heavy traffic areas, such as indoor commercial spaces, homes, and sports arenas. In one implementation, the communications service provider controls the small cell devices 110 through the ECM system 102 or based on inputs provided by the ECM system 102. In general, the communications service provider may deploy the small cell devices 110, in addition to macrocells (not shown in FIG. 1) to increase network capacity.

According to an implementation, the device management system 104 may include processor(s) 114, interface(s) 116, and memory 118 coupled to the processor(s) 114. Similarly, in one implementation, the prediction system 106 may also include processor(s) 132, interface(s) 134, and memory 136 coupled to the processor(s) 132.

The processor(s) 114 and the processor(s) 132 of the device management system 104 and the prediction system 106, respectively, may be implemented may be implemented as one or more microprocessors, microcomputers, microcontrollers, digital signal processors, central processing units, state machines, logic circuitries, and/or any devices that manipulate signals based on operational instructions. Among other capabilities, the processor(s) 114 and 132 are configured to fetch and execute computer-readable instructions stored in the memories 118 and 136.

The functions of the various elements shown in FIG. 1, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included.

Further, interface(s) 116 of the device management system 104 and interface(s) 134 of the prediction system 106 may include a variety of software and hardware interfaces that allow the ECM system 102 to interact with the entities of the network 108, a wide variety of networks and protocol types, including wire networks, for example, LAN, cable, etc., and wireless networks, for example, WLAN, cellular, satellite-based network, etc.

The memory 118 and the memory 136 may include any computer-readable medium known in the art including, for example, volatile memory, such as static random access memory (SRAM), and dynamic random access memory (DRAM), and/or non-volatile memory, such as read only memory (ROM), erasable programmable ROM, flash memories, hard disks, optical disks, and magnetic tapes.

Further, the device management system 104 may include module(s) 120 and data 122. The module(s) 120 include, for example, a signaling module 124 and other module(s) 126. The prediction system 106 may include modules(s) 138 and data 140. The module(s) 138 may include a clustering module 142, a prediction module 144, and other module(s) 146. The other module(s) 126 and the other module(s) 146 may include programs or coded instructions that supplement applications or functions performed by the ECM system 102.

In said implementation, the data 122 of the device management system 104 may include usage state data 128 and other data 130. Further, the data 140 of the prediction system 106 may include PM data 148 and other data 150. The other data 130 and other data 150 of the device management system 104 and the prediction system 106, respectively, amongst other things, may serve as a repository for storing data that is processed, received, or generated as a result of the execution of one or more modules in the module(s) 120 and in the modules(s) 138, respectively.

Although the data 140 is shown internal to the prediction system 106, it may be understood that the data 140 can reside in an external repository (not shown in the figure), which may be coupled to the prediction system 106. The prediction system 106 may communicate with the external repository through the interface(s) 134 to obtain information from the data 140.

According to an implementation, the signaling module 124 of the device management system 104 may enable performance management (PM) counters on each of a plurality of small cell devices 110. The PM counters are measurements of various parameters of the small cell devices 110. The PM counters gather information relating to the small cell devices 110. The PM counters may gather data related to a number of active calls of cellular devices, a number of hand-ins from neighbour small cell devices, and a number of connected cellular devices, hereinafter referred to as cellular equipments. In one example, to enable the PM counters on the small cell devices 110, the signaling module 124 may invoke technical report 069 (TR-069) remote procedure calls (RPC) “SetParameterValues”, on parameters related to the PM counters.

Once the signaling module 124 enables the PM counters on the small cell devices 110, the clustering module 142 of the prediction system 106 may receive performance management (PM) data or PM counts from the small cell devices 110 during a training phase. In an implementation, the training phase is performed before initialization of a process for reducing energy consumption of the small cell devices 110. Although, the process for reducing energy consumption of the small cell devices 110 (prediction phase) is always performed in real-time, however, the training phase may or may not be performed in real-time. For example, the training phase may be done offline, i.e., when the prediction system 106 is not connected to the device management system 104.

In one example, the clustering module 142 may receive the PM data from the small cell devices 110 via a network 108. The PM data may be indicative of information relating to usage patterns of the small cell devices 110 with respect to time, performance of the small cell devices 110, and traffic load in the small cell devices 110. According to an implementation, the clustering module 142 may store the received PM data within the PM data 148.

According to an implementation, during the training phase, upon receiving the PM data, the clustering module 142 may cluster the small cell devices 110 into one or more clusters based on the PM data. Each cluster comprises of at least one small cell device 110. In one implementation, the clustering module 142 may use a clustering algorithm, such as an independent component analysis (ICA) clustering algorithm to cluster the small cell devices 110. In one example, the clustering module 142 may cluster the small cell devices 110 based on the usage patterns of the small cell devices 110, such that small cell devices 110 having similar usage pattern may be grouped into one cluster. For example, the clustering module 142 may cluster the small cell devices 110 from a same area into a same cluster, for example, if the small cell devices 110 of the same area share similar usage characteristics, then those small cell devices 110 are put into one cluster.

Consider an example of small cell devices 110 deployed in a stadium. The small cell devices 110 may be serving one or more cellular equipments when at least one person is in the stadium and may be idle during other hours when no one is there in the stadium. In said example, the small cell devices 110 deployed in the stadium may be active from 6 AM to 10 AM and from 5 PM TO 8 PM, and may be inactive during other hours. Similarly, the small cell devices 110 deployed in a residence may be serving one or more cellular equipments when at least one resident is at home and may be idle during other hours when no one is at home. For example, the residents may be at work during working hours, say from 9 AM to 9 PM, and during this time interval, the small cell devices 110 may be idle.

Therefore, according to the above example, the clustering module 142 may cluster the small cell devices 110 into two clusters, one cluster having small cell devices 110 deployed in the stadium and other cluster having small cell devices 110 deployed in the residence. Further, it should be appreciated by those skilled in the art, that the PM data is dynamic in nature and changes with time and/or geographical location. Based on the same, the clusters of the small cell devices 110 may also get updated. For example, new small cell devices 110 may be added into the clusters and other small cell devices 110 may change their clusters, for example, if a usage pattern of a small cell device 110 changes, then the small cell device 110 may move to a different cluster. For example, the small cell devices 110, deployed in other deployment areas, such as offices, malls, etc., having a similar usage pattern as that of the small cell devices 110 deployed in the stadium or the residence, may be added to the respective cluster comprising the small cell devices 110 deployed in the stadium or the residence.

Upon clustering the small cell devices 110 into one or more clusters, the clustering module 142 may analyze, clean, and process the PM data, also referred to as training data, of each cluster. The clustering module 142 then feeds the training data in a conditional random field (CRF) model, where the CRF model learns its parameters. In one example, the clustering module 142 may train the CRF model using a stochastic gradient descent (SGD) method, quasi-Newton method, or a Limited-memory Broyden-Fletcher-Goldfarb-Shanno (L-BFGS) method.

The prediction accuracy of the trained CRF model may be tested against a separate set of PM data (called validation data). In one implementation, the training phase may be rerun on a regular basis, where the small cell devices 110 may change clusters or the CRF model's learned parameters may change.

Thereafter, the prediction phase, or the online phase, is performed when the prediction system 106 is connected to the device management system 104. The PM data for a particular cluster are accessed by the prediction system 106, which uses the learned CRF model for the cluster to predict next usage state for all the small cell devices 110 in the cluster.

In one implementation, the prediction system 106 may transmit the clusters to the device management system 104 through the network 108. The signaling module 124 of the device management system 104 may then associate a label with each cluster of the small cell devices 110. The label may be a distinctly identifiable name. Thus, the label may be used to identify a particular usage pattern. By associating labels with the small cell devices 110, it may become easy for the device management system 104 to target the small cell devices 110 contained in each cluster as a whole for any purpose. In one example, the signaling module 124 may associate a label “residence devices” with the cluster having the small cell devices 110 deployed in the residence and may associate a label “stadium devices” with the cluster having small cell devices 110 deployed in the stadium.

Thereafter, the signaling module 124 may then provide the labelled clusters of the small cell devices 110 to the prediction system 106 for further processing, through the network 108. In one implementation, the prediction module 144 of the prediction system 106 may predict a usage state for each cluster of the small cell devices 110 for a given time interval. The predicted usage state may be indicative of information relating to operation of the small cell devices 110 in the clusters. In one example, the predicted usage states may be dual states, such as either HIGH or LOW, or multiple states, such as LOW, MEDIUM, or HIGH. In one implementation, the prediction module 144 may predict the usage states of the clusters of the small cell devices 110 based on the usage pattern of the small cell devices 110 and a plurality of prediction parameters. The prediction parameters may be indicative of information relating to the small cell devices 110. In one example, the prediction parameters may include device parameters, performance data of the small cell devices 110, and environmental data. In one example, prediction parameters may include, but are not limited to, day of a week, time of the day, usage of the small cell devices 110 in past pre-determined minutes, usage of the small cell devices 110 at the pre-determined time for past pre-specified days, average load on nearby macrocells in the past pre-determined minutes, radio resource control (RRC) of the small cell devices 110, radio link control (RLC) of the small cell devices 110, and Handovers to and from the small cell devices 110. For example, the quantum of the preceding time (number of minutes or days) may be determined based on the required prediction performance of the prediction system 106.

In one implementation, the prediction module 144 execute the learned CRF model for predicting the next usage states of the clusters of the small cell devices 110 using the prediction parameters. Although the foregoing description has been described with reference to prediction of one usage state for a cluster for a given time interval, it is well appreciated that predictions may be made for any given cluster periodically for any specified time instance or time interval. Further, duration of the time intervals for each usage state may be determined may vary. For example, in one case, a usage state for a cluster may be inquired or predicted in every 1 hour and in other case, the usage state for the cluster may be predicted in every 15 minutes. Further, based on the usage state of the cluster, at every given instance, further action may be taken. In one implementation, the communications service provider who may be controlling the small cell devices 110, may provide the time intervals for which usage states of each cluster has to be determined.

Upon predicting the usage state of each cluster for the given time intervals, the prediction module 144 may transmit the predicted usage states to the device management system 104 through the network 108. In one implementation, the signaling module 124 of the device management system 104 may receive the predicted usage state for each cluster comprising at least one small cell device 110. As described above, the predicted usage states may be based on a pattern of usage of the at least one small cell device 110. The predicted usage state of each cluster may be indicative of information relating to operation of the at least one small cell device 110. According to an implementation, the clustering module 142 may store the received predicted usage states within the usage state data 128.

Subsequent to receiving the predicted usage state of each cluster, for a time interval, the signaling module 124 may generate a signal for each cluster based on the corresponding predicted usage state. It may be understood, the signaling module 124 generates one signal corresponding to a predicted usage state. The signal may be indicative of an action to be taken on the at least one small cell device 110 of each cluster to reduce energy consumption of the at least one small cell device 110. The action may include, but is not limited to, reducing RF power of the at least one small cell device 110, enabling standby mode of the at least one small cell device 110, switching OFF the at least one small cell device 110, and continuing a present mode of the at least one small cell device 110. The present mode may be either an active mode or an inactive mode.

For example, if a predicted usage state of a cluster is LOW, i.e., small cell devices 110 of the cluster may not be serving cellular equipments connected to the small cell devices 110, then the signaling module 124 may generate a signal corresponding to the predicted usage state, for example, to enable an inactive mode for the small cell devices 110. Thus, in one implementation, the communications service provider, controlling the small cell devices 110, may select an action to be taken on each cluster corresponding to the predicted usage state. In one example, the communications service provider may select an action “switch OFF” from amongst the above mentioned actions to be taken on each cluster for reducing energy consumption of the small cell devices 110 corresponding to each cluster. Based on the action, the communications service provider may switch OFF the small cell devices 110 contained in the cluster, to reduce the energy consumption of the small cell devices 110.

In one implementation, the signaling module 124 may further generate the signal for each cluster based on applying a pre-defined schedule policy. The pre-defined schedule policy may be indicative of a time schedule associated with duration of at least one of an active mode and an inactive mode of the small cell devices 110. In other words, the pre-defined schedule policy may comprise of one or more time intervals during which the small cell devices 110 have to be kept on an active mode or on an inactive mode. In said implementation, the schedule policy may be made available to the device management system 104 by the communications service provider who is controlling the small cell devices 110. The communications service provider may formulate the schedule policy based on a user's choice. The user may be understood as a person who has deployed the small cell devices 110 in a deployment area. For example, the user may be an owner of a house, a public entity managing a public deployment, etc. Further, the communications service provider may configure the pre-defined schedule policy on the device management system 104. It will be understood, that application of the pre-defined schedule policy by the signaling module 124 to generate the signal for each cluster may be optional.

Referring to the an example, a predicted usage state of “office devices” cluster may be LOW for a time interval between 10 PM to 9 AM on working days, and may be HIGH for the time interval between 10 AM to 10 PM on the working days. The “office devices” cluster may be understood as a cluster of small cell devices 110 deployed in an office or cluster of small cell devices 110 with usage pattern same as that of small cell devices 110 deployed in the office. Further, according to the pre-defined schedule policy, the small cell devices in the “office devices” may be kept on an inactive mode for time interval between 10 AM to 11 AM, for example, if most of the employees reach office by 11 AM. In such a case, the network may select an action “reduce RF power” for the small cell devices 110 contained in the “office devices” cluster, thereby reducing energy consumption of the small cell devices in the “office devices” cluster from 10 AM to 11 AM.

Since usage pattern of each small cell device 110 is taken into consideration to cluster the small cell devices 110 into one or more clusters, and usage state for each cluster is predicted, it becomes easy to target each cluster as a whole and separate policies need not he defined for the numerous individual small cell devices 110. Also, there is no need to generate a signal for each and every small cell device 110. A signal is generated for each cluster of small cell devices 110. As a result, less time is consumed and it becomes easy to manage the small cell devices 110. Thus, according to the present subject matter, energy consumption of small cell devices 110 is efficiently reduced, without any errors.

Thus the small cell devices 110 are not unnecessarily ON to avoid wastage of power and at the same time are not OFF when they may he required to provide cellular services. Thus, the ECM system 102 reduces energy consumption of the small cell devices 110 in a time efficient and error free manner.

FIG. 2 illustrates a method 200 for reducing energy consumption of small cell devices, in accordance with an embodiment of the present subject matter. The order in which the method is described is not intended to be construed as a limitation, and any number of the described method blocks can be combined in any order to implement the method 200 or any alternative method. Additionally, individual blocks may be deleted from the method without departing from the spirit and scope of the subject matter described herein. Furthermore, the method can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the method(s) 200 can be performed by programmed computers. Herein, some embodiments are also intended to cover program storage devices or computer readable medium, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices to perform said steps of the method(s).

At block 202, the method 200 may include receiving performance management (PM) data from small cell devices. To receive the PM data, performance management (PM) counters on the small cell devices may be enabled. In one example, the small cell devices may generate the PM data for the enabled PM counters. The PM data may be indicative of information relating to usage patterns of the small cell devices with respect to time, performance of the small cell devices, and traffic load in the small cell devices. In one implementation, the clustering module 142 of the prediction system 106 may receive the PM data from the small cell devices 110.

At block 204, the method 200 may include clustering the small cell devices into one or more clusters based on the PM data. In one implementation, the clustering of the small cell devices may he done using a clustering algorithm, such as an independent component analysis (ICA) clustering, k nearest neighbours or k-means clustering algorithm. In one example, the clustering of the small cell devices may be based on the usage patterns of the small cell devices, such that small cell devices having similar usage pattern may be grouped into one cluster. According to an implementation, the clustering module 142 of the prediction system 106 may cluster the small cell devices 110 into one or more clusters based on the PM data.

At block 206, the method 200 may include predicting a usage state for each cluster for a time interval, where the usage state is based on usage patterns of the small cell devices and on a plurality of prediction parameters predicted for a time interval. The predicted usage state may be indicative of information relating to operation of the small cell devices in each cluster. In one example, the predicted usage states may be dual states, such as either HIGH or LOW, or multiple states, such as LOW, MEDIUM, or HIGH. Further, the prediction parameters may be indicative of information relating to the small cell devices, such as day of a week, time of the day, usage of the small cell devices in past pre-determined minutes, usage of the small cell devices at the pre-determined time for past pre-specified days, and average load on nearby macrocells in the past pre-determined minutes. In one implementation, the prediction module 144 of the prediction system 106 may predict a usage state for each cluster of the small cell devices 110 for a given time interval.

At block 208, the method 200 may include generating a signal for the cluster based on the predicted usage state, where the signal is indicative of an action to be taken on the small cell devices to reduce energy consumption of the small cell devices. The action may include, but is not limited to, reducing radio frequency (RF) power of the at least one small cell device, enabling standby mode of the at least one small cell device, switching OFF the at least one small cell device, and continuing a present mode of the at least one small cell device. The present mode may be either an active mode or an inactive mode. In one implementation, the communications service provider, controlling the small cell devices, may select an action to be taken on each cluster corresponding to the predicted usage state. In one implementation, generation of the signal for each cluster may also be based on applying a pre-defined schedule policy. The pre-defined schedule policy may be indicative of a time schedule comprising one or more time intervals during which the small cell devices have to be kept on an active mode or on an inactive mode. In one implementation, the signaling module 124 of the device management system 104 may generate a signal for each cluster based on the corresponding predicted usage state.

In one implementation, the method blocks 206 and 208 described above may be repeated for each time interval, provided by the communications service provider to the ECM system 102.

Although embodiments for reducing energy consumption of small cell devices have been described in a language specific to structural features or method(s), it is to be understood that the invention is not necessarily limited to the specific features or method(s) described. Rather, the specific features and methods are disclosed as embodiments for reducing energy consumption of small cell devices

1. A device management system for reducing energy consumption of small cell devices, the device management system comprising:
a processor; and
a signaling module coupled to the processor to:
receive a predicted usage state of a cluster comprising at least one small cell device, wherein the cluster is formed based on a pattern of usage, and wherein the predicted usage state is indicative of information relating to operation of the at least one small cell device; and
determine an action to be taken for the cluster based on the predicted usage state, wherein the action relates to one of maintaining and changing an operational state of the at least one small cell device.

2. The device management system as claimed in claim 1, wherein the signaling module receives the predicted usage state of the cluster for a time interval.

3. The device management system as claimed in claim 1, wherein the signaling module determines the action based on applying a pre-defined schedule policy, and wherein the pre-defined schedule policy is indicative of a time schedule associated with a duration of at least one of an active mode and an inactive mode of the at least one small cell device.

4. The device management system as claimed in claim 1, wherein the predicted usage state comprises one of HIGH, MEDIUM, and LOW.

5. The device management system as claimed in claim 1, wherein the action comprises one of reducing radio frequency (RF) power of the at least one small cell device, enabling standby mode of the at least one small cell device, switching OFF the at least one small cell device, and continuing a present mode of the at least one small cell device, the present mode being one of an active mode and an inactive mode.

6. The device management system as claimed in claim 1, wherein the signaling module further associates a label with the cluster having the at least one small cell device, and wherein the label is a distinctly identifiable name.

7. The device management system as claimed in claim 1 further comprising a prediction system, wherein the prediction system comprises:
a clustering module coupled to a processor to:
receive performance management (PM) data from a plurality of small cell devices, wherein the PM data is indicative of information relating to at least usage patterns of the plurality of small cell devices;
cluster the plurality of small cell devices into one or more clusters, each cluster having the at least one small cell device; and
a prediction module coupled to the processor to predict the usage state for each of the one or more clusters for a time interval based on the usage patterns of the plurality of small cell devices and a plurality of prediction parameters, wherein the plurality of prediction parameters is indicative of information relating to the plurality of small cell devices.

8. The device management system as claimed in claim 7, wherein the information relating to the plurality of small cell devices comprises day of a week, time of the day, usage of the plurality of small cell devices in past pre-determined minutes, usage of the plurality of small cell devices at the pre-determined time for past pre-specified days, average load on nearby macrocells in the past pre-determined minutes, radio resource control (RRC) of the small cell devices, radio link control (RLC) of the small cell devices, and Handovers to and from the small cell devices.

9. A method for reducing energy consumption of small cell devices, the method comprising:
receiving a predicted usage state of a cluster comprising at least one small cell device, wherein the cluster is formed based on a pattern of usage, and wherein the predicted usage state is indicative of information relating to operation of the at least one small cell device; and
determining an action to be taken for the cluster based on the predicted usage state, wherein the action relates to one of maintaining and changing an operational state of the at least one small cell device.

10. The method as claimed in claim 9, wherein the action comprises one of reducing radio frequency (RF) power of the at least one small cell device, enabling standby mode of the at least one small cell device, switching OFF the at least one small cell device, and continuing a present mode of the at least one small cell device, the present mode being one of an active mode and an inactive mode.

11. The method as claimed in claim 9, wherein the method further comprising:
enabling one or more performance management (PM) counters on each of a plurality of small cell devices; and
receiving PM data from the plurality of small cell devices based on the enabling, wherein the PM data is indicative of information relating to at least usage patterns of the plurality of small cell devices.

12. The method as claimed in claim 9, wherein the method further comprising clustering a plurality of small cell devices into one or more clusters, each cluster having the at least one small cell device.

13. The method as claimed in claim 9, wherein the method further comprising predicting the usage state for each of the one or more clusters for a time interval based on the usage patterns of the plurality of small cell devices and a plurality of prediction parameters, and wherein the plurality of prediction parameters is indicative of information relating to the plurality of small cell devices.

14. A non-transitory computer-readable medium having embodied thereon a computer program, which when executed by a computer causes the computer to:
receive a predicted usage state of a cluster comprising at least one small cell device, wherein the cluster is formed based on a pattern of usage, and wherein the predicted usage state is indicative of information relating to operation of the at least one small cell device; and
determine an action to be taken for the cluster based on the predicted usage state, wherein the action relates to one of maintaining and changing an operational state of the at least one small cell device.

15. The non-transitory computer-readable medium as claimed in claim 14, wherein the computer is further caused to cluster a plurality of small cell devices into one or more clusters, each cluster having the at least one small cell device.
